(19) United States
(12) Patent Application Publication
(10) Pub. No.: US 2006/0137711 A1
(43) Pub. Date: Jun. 29, 2006

(54) SINGLE-WAFER CLEANING PROCEDURE

(76) Inventor: Kun-Yuan Liao, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 10/905,316

(22) Filed: Dec. 27, 2004

(51) Int. Cl. B08B 6/00; C23G 1/00

(52) U.S. Cl. 134/1.2; 134/1.3; 134/2

(57) ABSTRACT

A single-wafer dry cleaning procedure. First, an etched wafer having a photo resist pattern thereon is provided. Then, an ashing process is performed to remove the photo resist pattern. Finally, the etched wafer is hoisted and maintained in a suspended condition, a dry cleaning process then being performed upon the etched wafer.

### BACKGROUND OF INVENTION

1. Field of the Invention

The present invention relates to a single-wafer cleaning procedure, and more particularly, to a single-wafer dry cleaning procedure performed when the wafer is in a hoisted condition.

2. Description of the Prior Art

The manufacturing of VLSI, ULSI, and MEMS are based on a substrate, e.g. a silicon wafer, and are successively implemented by performing hundreds of processes including thin film deposition, oxidization, photolithography, etching, implantation, etc. An example of forming a gate structure of an MOS element is described as follows. First of all, a gate insulating layer, a polysilicon layer, and a polycide layer are consecutively formed on a wafer. Then, a photolithography process is utilized to form a photo resist pattern on the wafer surface to define the position of the gate structure. Following that, an etching process is performed to remove the gate insulating layer, the polysilicon layer, and the polycide layer thus forming the gate structure. As known in the art, however, polymer particles, which are the products of the etching reaction, would adhere to the wafer surface, and thus a cleaning process must be performed to remove the polymer products. In such a case, the electrical performance of the MOS element can be ensured, and subsequent processes can be continued successfully.

Please refer to FIG. 1. FIG. 1 is a flow chart illustrating a conventional wafer cleaning procedure. As shown in FIG. 1, the conventional wafer cleaning procedure includes the following steps:

Step 10: utilizing a photolithography process to form a photo resist pattern on a thin film positioned on a wafer surface;

Step 20: performing an ashing process by introducing oxygen at a high temperature to remove the photo resist pattern; and

Step 30: performing a wet cleaning process by immerse the wafer into at least a cleaning solution tank to remove the polymer particles adhered to the wafer surface (including front surface, back surface, and bevel surface), and rinsing the wafer with deionized (DI) water.

The aforementioned wafer cleaning procedure is a common way to clean wafers. However, the concentration of the cleaning solution varies with the quantity of wafers processed. That is, considering wafers of different batches, the cleaning effect of the solution on wafers of any given batch is inevitably poorer compared to the cleaning effect on wafers of a previous batch. Consequently, the quality of subsequent processes is more difficult to control. In the mass production of small-sized wafers, since the critical dimensions are larger and the integration is not high, the conventional cleaning procedure by performing a wet cleaning process is an acceptable solution. However, because critical dimensions are reduced and integration is improved in the fabrication of 12-inch wafers, a single-wafer cleaning procedure is necessary to ensure effective cleaning.

As described above, the process precision involved in the fabrication of large-sized wafers requires strict cleanliness controls, and hence a single-wafer cleaning procedure must be adopted. In addition, if the single-wafer cleaning procedure is implemented by a wet cleaning process in a spinning manner, particles such as polymer particles or organic components would remain on the back surface and the bevel surface of the wafers. These remaining polymer particles become the source of contamination in the chambers of subsequent processes, and therefore affect the quality and yield of these processes.

### SUMMARY OF INVENTION

It is therefore a primary object to provide a single-wafer dry cleaning procedure to overcome the aforementioned problem.

According to a preferred embodiment of the present invention, a single-wafer dry cleaning procedure is disclosed. First, an etched wafer including a photo resist pattern thereon is provided. An ashing process is thereafter performed to remove the photo resist pattern. Finally, the etched wafer is hoisted up, and a dry cleaning process is performed upon the etched wafer.

Since the dry cleaning process, e.g. oxygen plasma bombardment, is performed when the etched wafer is in a hoisted condition according to the present invention, polymer particles adhering to the back surface and the bezel surface of the etched wafer are easily removed.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a flow chart illustrating a conventional wafer cleaning procedure.

FIG. 2 and FIG. 3 are schematic diagrams illustrating a dry cleaning procedure according to a preferred embodiment of the present invention.

FIG. 4 is a schematic diagram illustrating a dry cleaning procedure according to another embodiment of the present invention.

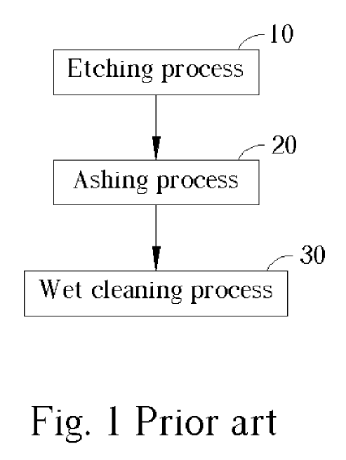

### DETAILED DESCRIPTION

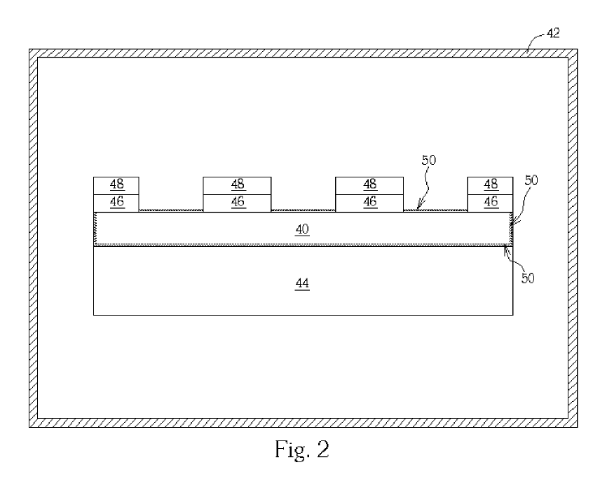

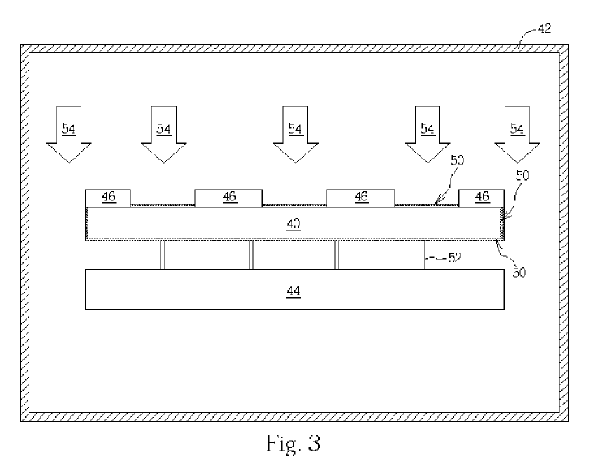

Please refer to FIG. 2 and FIG. 3. FIG. 2 and FIG. 3 are schematic diagrams illustrating a dry cleaning procedure according to a preferred embodiment of the present invention. As shown in FIG. 2, a wafer which has just been etched (hereinafter referred to as etched wafer 40) is loaded into a reaction chamber 42, and supported by a carrier 42. The etched wafer 40 includes a thin film pattern 46, and a photo resist pattern 48 on the front surface for defining the thin film pattern 46. In addition, the etched wafer 40 randomly includes a plurality of polymer particles 50 (or organic components), generated during the etching process, on the front surface, the back surface, and the bevel surface. Following that, an ashing process is performed by, such as introducing oxygen, ozone, or utilizing oxygen-carbon tetrafluoride (O₂—CF₄) plasma, nitrogen oxygen (N₂—O₂) plasma, at a temperature within 100° C. to 300° C. to remove the photo resist pattern 48.

As shown in FIG. 3, after the photo resist pattern 48 positioned on the front surface of the etched wafer 40 is removed in the ashing process, the etched wafer 40 is then hoisted up by pins 52 of the carrier 44 and undergoes a dry cleaning process in an in-situ manner. In this embodiment, the process temperature is maintained under a low pressure and within 100° C. to 300° C. In addition, a plasma, e.g. an oxygen plasma 54, is utilized to bombard the etched wafer 40 when the etched wafer 40 is in a hoisted condition. Accordingly, the oxygen plasma 54 is capable of removing the polymer particles on the front surface, and the polymer particles 50 adhered to the back surface and the bevel surface of the etched wafer 40 as well.

Since the main characteristic of the present invention is to perform a dry cleaning process upon the etched wafer 40, the etched wafer 40 being hoisted, other suitable cleaning methods can also be adopted to remove the polymer particles 50. For example, the polymer particles 50 on the front surface, back surface, and bevel surface can be burned away by introducing at least a gas (e.g. oxygen or ozone) at a high temperature. In addition, since the plasma substantially consists of charged ions, radicals, molecules, and electrons, a certain portion of the plasma can be selected to bombard the etched wafer 40 so as to improve the cleaning effect of the dry cleaning process.

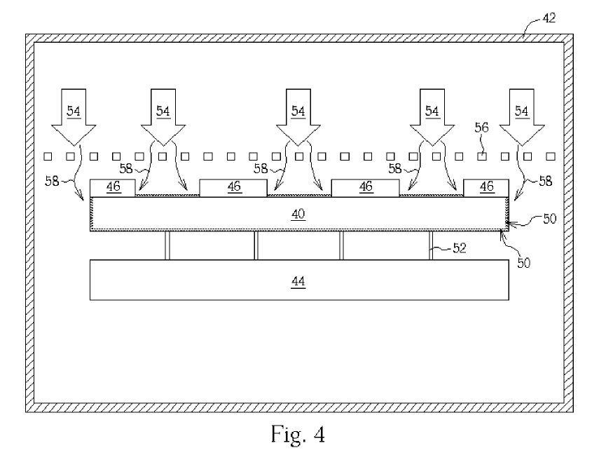

Please refer to FIG. 4. FIG. 4 is a schematic diagram illustrating a dry cleaning procedure according to another embodiment of the present invention. It is appreciated that like numerals represent like components in FIG. 3 and FIG. 4. As shown in FIG. 4, what is different from the previous embodiment is that in this embodiment the radicals 58 of the oxygen plasma 54 are select to bombard the etched wafer 40. Consequently, a filter 56 is installed over the etched wafer 40 for only allowing the radicals 58 of the oxygen plasma 54 to pass through. Accordingly, the radicals 58 can remove the polymer particles 50 adhered to the front surface, the back surface, and the bevel surface of the etched wafer 40.

It is to be appreciated that the dry cleaning process aims to remove the polymer particles adhered to the front surface, the back surface, and the bevel surface of the etched wafer when the etched wafer is in a hoisted condition. On the other hand, the ashing process is also a dry process, which works to remove the photo resist pattern positioned on the front surface of the etched wafer. However, the dry cleaning process of the present invention can be implemented in a low pressure reaction chamber, in which the wafer is hoisted, by performing a single plasma process to remove the photo resist pattern and the polymer particles simultaneously. In addition, to ensure the cleanness of the etched wafer, a wet cleaning process can also be performed on the etched wafer after the dry cleaning process. Since the etched wafer may include only a small amount of polymer particles, the concentration of the cleaning solution is not altered dramatically.

In conclusion, the prior art utilizes a wet cleaning process to remove the polymer particles adhered to the etched wafer, and thus suffers from variations in the concentration of the cleaning solution. For large-sized wafers, the above-mentioned wet cleaning process is not an acceptable solution in the removal of polymer particles. In comparison with the prior art, the present invention utilizes a dry cleaning process to remove the polymer particles adhered to the front surface, the back surface, and the bevel surface of the etched wafer, and thus has a stable cleaning ability to remove the polymer particles effectively.

Those skilled in the art will readily observe that numerous modifications and alterations of the device and method may be made while retaining the teachings of the invention. Accordingly, the above disclosure should be construed as limited only by the metes and bounds of the appended claims.

1. A single-wafer cleaning procedure, comprising:
providing an etched wafer comprising a photo resist pattern on a front surface of the etched wafer;
performing an ashiing process to remove the photo resist pattern; and
hoisting the etched wafer, and performing a dry cleaning process upon the etched wafer.

2. The procedure of claim 1, wherein the etched wafer comprises a plurality of polymer particles adhered to the front surface, a back surface, and a bevel surface of the etched wafer.

3. The procedure of claim 2, wherein the dry cleaning process is performed for removing the polymer particles.

4. The procedure of claim 1, wherein the dry cleaning process is performed with a gas.

5. The procedure of claim 1, wherein the dry cleaning process is performed with an oxygen plasma.

6. The procedure of claim 5, wherein the oxygen plasma comprises charged ions, radicals, molecules, and electrons.

7. The procedure of claim 6, wherein during the dry cleaning process, a filter is installed over the etched wafer for only allowing the radicals to pass through.

8. The procedure of claim 1, wherein the dry cleaning process is performed at a temperature ranging from 100° C. to 300° C.

9. The procedure of claim 1, wherein the ashing process and the dry cleaning process are performed in an in-situ manner in a low pressure reaction chamber.

10. The procedure of claim 9, further comprising performing a wet cleaning process after the dry cleaning process is performed.

11. The procedure of claim 1, wherein the etched wafer is hoisted up with a pin-up function of a carrier.

12. A single-wafer dry cleaning procedure, comprising:
providing a wafer, the wafer being an etched wafer, and the etched wafer comprising a plurality of polymer particles adhered to a front surface, a back surface, and a bevel surface of the wafer; and
hoisting the wafer with a pin-up function of a carrier, and performing a dry cleaning process to remove the polymer particles adhered to the front surface, the back surface and the bevel surface of the wafer.

13. The procedure of claim 12, wherein the wafer comprises a photo resist pattern on the front surface of the wafer.

14. (canceled)

15. The procedure of claim 13, wherein the dry cleaning process further removes the photo resist pattern.

16. The procedure of claim 12, further comprising performing an ashing process before the dry cleaning process is performed.

17. The procedure of claim 16, wherein the ashing process and the dry cleaning process are performed in an in-situ manner in a low pressure reaction chamber.

18. The procedure of claim 12, wherein the dry cleaning process is performed at a temperature ranging from 100° C. to 300° C.

19. The procedure of claim 12, wherein the dry cleaning process is performed with a gas.

20. The procedure of claim 19, wherein the dry cleaning process further comprises a step of discharging the gas to generate a plasma.

21. The procedure of claim 20, wherein the plasma comprises charged ions, radicals, molecules, and electrons.

22. The procedure of claim 21, wherein during the dry cleaning process, a filter is installed over the wafer for only allowing the radicals to pass through.

23. The procedure of claim 12, further comprising performing a wet cleaning process after the dry cleaning process is performed.
